(19) United States
(12) Patent Application Publication
(10) Pub. No.: US 2005/0259512 A1
(43) Pub. Date: Nov. 24, 2005

(54) Acoustic caliper with transducer array for improved off-center performance

(75) Inventor: Batakrishna Mandal, Missouri City, TX (US)

Correspondence Address: CONLEY ROSE, P.C., PO BOX 3267, HOUSTON, TX, 77253-3267, US

(73) Assignee: Halliburton Energy Services, Inc., Houston, TX (US)

(21) Appl. No.: 10/852,647

(22) Filed: May 24, 2004

(51) Int. Cl. G03H 3/00

(52) U.S. Cl. 367/10

(57) ABSTRACT

An acoustic caliper and a calipering method having reduced or eliminated blind spots. In one embodiment, the acoustic caliper comprises an array of two or more transducers that can detect acoustic pulses transmitted by other transducers in the array. One method embodiment comprises: transmitting an acoustic pulse from a selected transducer in a transducer array; configuring the array to listen for a reflection of the acoustic pulse; and determining a travel time for the acoustic pulse if a reflection is detected by at least one transducer in the array.

### BACKGROUND

Modem petroleum drilling and production operations demand information relating to parameters and conditions downhole. Such information typically includes borehole size and configuration, tool position within the borehole, and earth formation properties around the borehole. Several methods exist for downhole information collecting (“logging”), including conventional wireline logging and logging while drilling (“LWD”).

In conventional wireline logging, a probe (“sonde”) is lowered into the borehole after some or all of the well has been drilled. The sonde is suspended from a conductive wireline that supplies power to instruments within the sonde. The instruments measure certain borehole and surrounding formation characteristics, and communicate measurements to the surface using using electrical signals transmitted through the wireline.

In LWD, data is typically collected during the drilling process, thereby avoiding any need to remove the drilling assembly to insert a wireline logging tool. LWD consequently allows the driller to make accurate real-time modifications or corrections to optimize performance while minimizing down time. “Measurement-while-drilling” (MWD) is the term for measuring conditions downhole concerning the movement and location of the drilling assembly while the drilling continues. “Logging-while-drilling” (LWD) is the term for similar techniques that concentrate more on formation parameter measurement. While distinctions between MWD and LWD may exist, the terms MWD and LWD often are used interchangeably. For the purposes of this disclosure, the term LWD will be used with the understanding that this term encompasses both the collection of formation parameters and the collection of information relating to the movement and position of the drilling assembly.

In LWD systems, instruments are typically located at the lower end of the drill string. More specifically, the downhole instruments are typically positioned in a cylindrical drill collar positioned near the drill bit. While drilling is in progress these instruments continuously or intermittently monitor predetermined drilling parameters and formation data and transmit the information to a surface detector by some form of telemetry. Alternatively, the data can be stored while the instruments are downhole, and recovered at the surface later when the drill string is retrieved.

One of the many instruments that may be employed in LWD or wireline logging is a borehole caliper. The caliper measures the borehole size and the logging tool's position in the borehole. Such parameters are important as they may be used to compensate other instruments' measurements. Some caliper tools may be further configured to determine the shape of non-circular boreholes. (The cross-sectional shape of a borehole can be helpful in measuring various properties of the formation, such as stress, porosity, and density.)

Though calipers are available in various types, the acoustic caliper is popular. Because the acoustic caliper uses acoustic (often ultrasonic) signals for distance measurements, it has no moving mechanical parts that could be subject to failure. Unfortunately, as existing calipers become offset from the borehole's center, they suffer “blind spots”—azimuthal zones where distance measurements cannot be made directly. In the wireline application, the offset can be limited with the use of a centralizer, but in LWD applications a centralizer cannot be used. In such circumstances, it would be desirable to have an acoustic caliper where such blind spots were reduced in size or eliminated entirely.

### SUMMARY

Accordingly, there is disclosed herein an acoustic caliper and a calipering method having reduced or eliminated blind spots. In one embodiment, the acoustic caliper comprises an array of two or more transducers that can detect acoustic pulses transmitted by other transducers in the array. One method embodiment comprises: transmitting an acoustic pulse from a selected transducer in a transducer array; configuring the array to listen for a reflection of the acoustic pulse; and determining a travel time for the acoustic pulse if a reflection is detected by at least one transducer in the array.

### BRIEF DESCRIPTION OF THE DRAWINGS

A better understanding of the disclosed embodiments can be obtained when the following detailed description is considered in conjunction with the following drawings, in which:

FIG. 1 shows a representative logging-while-drilling (LWD) configuration;

FIG. 2 shows an illustrative embodiment of an acoustic caliper;

FIG. 3 shows a schematic cross-sectional view of an acoustic caliper in a borehole;

FIG. 4 shows an acoustic pulse from a single transducer reflecting from an angled surface;

FIG. 5 shows a schematic cross-sectional view of an improved acoustic caliper in a borehole;

FIG. 6 shows an acoustic pulse from a transducer array reflecting from an angled surface;

FIGS. 7a-7d show illustrative transducer array variations;

FIG. 8 shows a block diagram of an illustrative acoustic caliper system; and

FIG. 9 shows a flowchart of an illustrative method that may be implemented by the system of FIG. 8.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### Notation and Nomenclature

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections. The terms upstream and downstream refer generally, in the context of this disclosure, to the transmission of information from subsurface equipment to surface equipment, and from surface equipment to subsurface equipment, respectively. Additionally, the terms surface and subsurface are relative terms. The fact that a particular piece of hardware is described as being on the surface does not necessarily mean it must be physically above the surface of the earth; but rather, describes only the relative placement of the surface and subsurface pieces of equipment.

### DETAILED DESCRIPTION

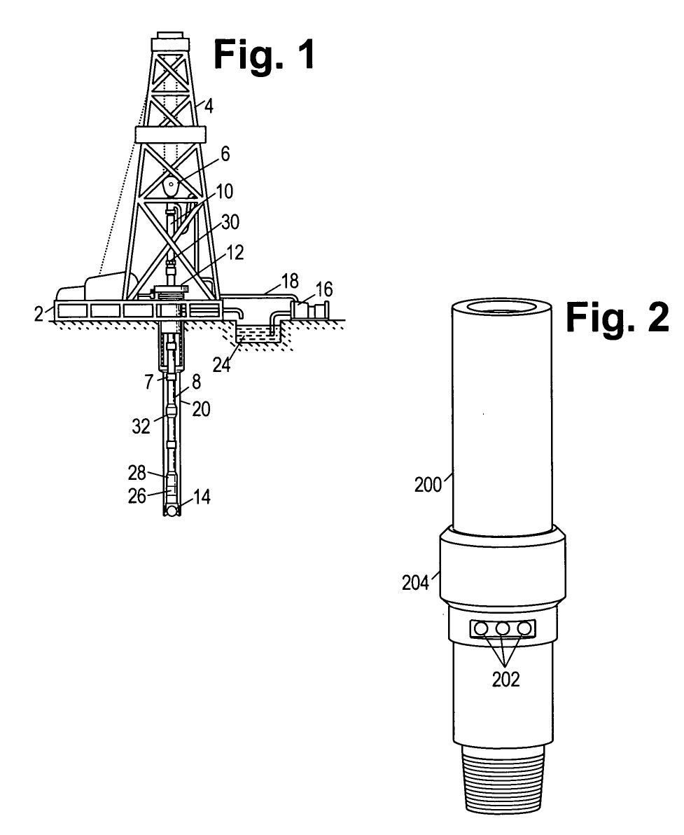

Turning now to the figures, FIG. 1 shows a representative well during drilling operations. A drilling platform 2 is equipped with a derrick 4 that supports a hoist 6. Drilling of oil and gas wells is typically carried out with a string of drill pipes connected together by “tool” joints 7 so as to form a drill string 8. The hoist 6 suspends a kelly 10 that is used to lower the drill string 8 through rotary table 12. A drill bit 14 is connected to the lower end of the drill string 8. The bit 14 is rotated by rotating the drill string 8 or by operating a downhole motor near the drill bit. The rotation of the bit 14 extends the borehole.

Recirculation equipment 16 pumps drilling fluid through supply pipe 18, through drilling kelly 10, and down through the drill string 8 at high pressures and volumes to emerge through nozzles or jets in the drill bit 14. The drilling fluid then travels back up the hole via the annulus between the drill string 8 and the borehole wall 20, through the blowout preventer (not specifically shown), and into a mud pit 24 on the surface. On the surface, the recirculation equipment 16 cleans and recirculates the drilling fluid. The drilling fluid cools the drill bit 14, carries drill cuttings to the surface, and balances the hydrostatic pressure in the rock formations.

Downhole instrument sub 26 may be coupled to a telemetry transmitter 28 that communicates with the surface, providing telemetry signals and receiving command signals. A surface transceiver 30 may be coupled to the kelly 10 to receive transmitted telemetry signals and to transmit command signals downhole. Alternatively, the surface transceiver may be coupled to another portion of the rigging or to drillstring 8. One or more repeater modules 32 may be provided along the drill string to receive and retransmit the telemetry and command signals. The surface transceiver 30 is coupled to a logging facility (not shown) that may gather, store, process, and analyze the telemetry information.

In one illustrative embodiment, downhole instrument sub 26 includes an acoustic caliper. FIG. 2 shows an illustrative acoustic caliper embodiment 200. Acoustic caliper 200 has an array of acoustic transducers 202 and an optional “wear band” 204. Wear band 204 may serve to protect the transducer array 202 by maintaining a minimum distance between the borehole wall and the tool face. A secondary purpose of wear band 204 may be to limit the maximum offset from the borehole center.

Acoustic caliper embodiment 200 employs an array of three transducers to reduce or eliminate blind spots, although more or fewer transducers may be used. The transducers may be piezoelectric transducers configured to transmit acoustic pulses and receive reflected acoustic pulses. Acoustic calipers measure a time delay between a transmission of a pulse and reception of its reflection. A path length can be calculated by combining the time delay with the speed of sound in the fluid. The sound velocity may vary with the composition, pressure, and temperature of the drilling fluid, though the variation may be insignificant for many applications. Accordingly, the sound velocity may be assumed to be a constant value, or if temperature and pressure measurements are available, the sound velocity may be estimated based on known pressure and temperature coefficients.

A standoff distance (the distance between the transducer(s) and the borehole wall) can be readily determined from the path length. In the case of a single transducer, the acoustic pulse has traveled from the transducer to the borehole wall and back, causing the path length to be twice the standoff distance. If the acoustic pulse has traveled from one transducer to the borehole wall and back to another transducer, the relationship between path length and standoff distance is somewhat more complex. Nevertheless, an analysis of the tool geometry will yield a straightforward, though approximate, expression of standoff distance as a function of path length. If an acoustic pulse has traveled from one transducer to the borehole wall and back to two or more transducers, two path lengths will be calculated and an exact (i.e., not based on an approximate expression) standoff distance can be determined.

As the drill string (and the acoustic caliper) rotates, standoff distances can be measured in each direction to determine the borehole shape and the position of the caliper within the borehole. Acoustic caliper 200 includes an azimuthal sensor and/or a motion sensor to allow standoff distance to be measured as a function of caliper orientation and position. The azimuthal sensor may include a magnetometer to sense tool orientation relative to the local magnetic field, and/or an accelerometer to sense tool orientation relative to the local gravitational field. If present, the accelerometer may also serve as a motion sensor, allowing changes in tool position to be tracked and combined with standoff distance measurements to obtain improved borehole diameter and shape calculations.

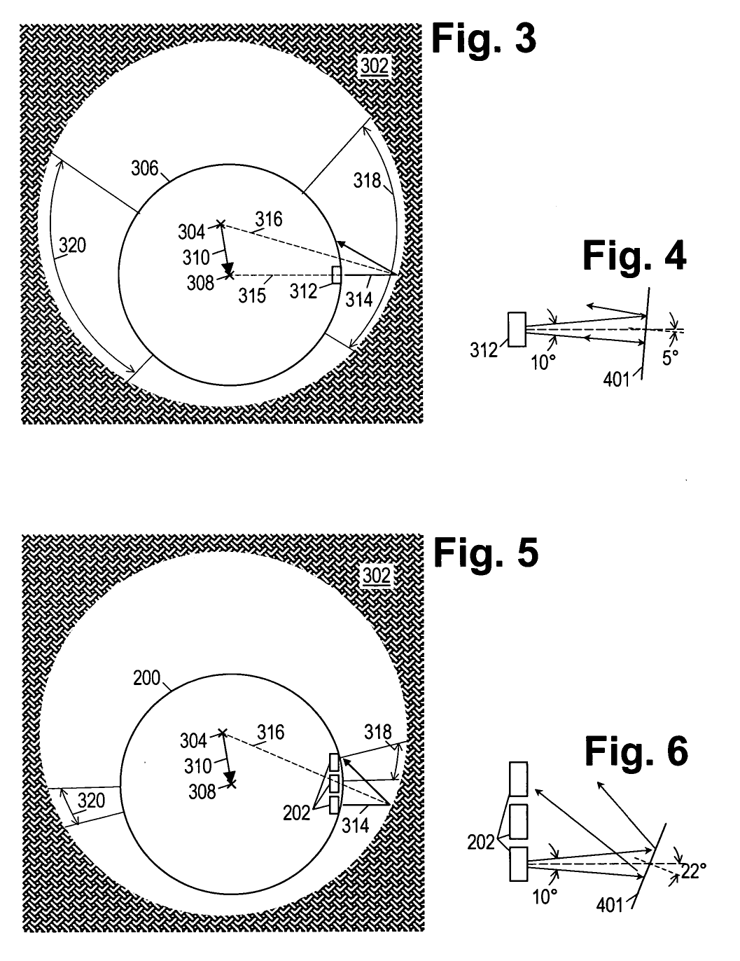

FIG. 3 illustrates the cause of blind spots. FIG. 3 shows a formation 302 penetrated by a borehole having a circular cross-section with a center point 304. Positioned within the borehole is an acoustic caliper 306 with a center point 308. The caliper center point 308 is displaced from borehole center point 304 by an offset 310. Transducer 312 transmits acoustic pulses 314 as the tool rotates. The pulses 314 travel away from transducer 312 along a line 315 extending through transducer 312 from caliper center point 308. The pulses 314 encounter the borehole wall at an angle to the normal 316. (The normal is a line perpendicular to the borehole surface. In a circular borehole, this line always passes through the borehole center 304.) The angle between lines 315 and 316 is called the incidence angle. The pulses 314 reflect from the borehole wall at an angle to the normal. (The angle of reflection equals the incidence angle.) If the incidence angle is too large, transducer 312 is unable to receive the reflected pulses.

When the acoustic caliper 306 is nearly centered within the borehole, the incidence angle is small at all points on the borehole circumference, and the transducer 312 is able to receive the reflected pulses 314. When offset 310 increases, lines 315 and 316 form different incidence angles at different positions on the borehole wall. For a sufficiently large offset 310, the acoustic caliper encounters blind spots 318 and 320 where the incidence angle is too large.

As an example of when the incidence angle becomes too large, consider a transducer 312 having a 10° beam width (see FIG. 4). When such a beam strikes a (flat) surface 401 at an incidence angle of 5°, only the edge of the beam is reflected back in the direction of the transducer. Larger incidence angles will allow transducer 312 to receive only the fringes of the beam, and indeed, once the incidence angle exceeds 10°, the energy reflected in the transducer's direction may fall below the detection limit. If the surface 401 is concave, the limit on the incidence angle becomes even smaller. An acoustic caliper tool in a 12-inch diameter borehole may reach the incidence angle limit with offsets as small as 0.75 inches.

FIG. 5 illustrates an acoustic caliper embodiment 200 in which the blind spots 318, 320 have been reduced or eliminated. (The blind spot size is dependent on the offset.) Caliper 200 includes a transducer array 202 having three transducers. The transducer arrangement allows detection of acoustic pulse reflections at higher angles of incidence than would be the case in the embodiment of FIG. 3. In one operational mode, each of the three transducers is fired in turn. After each firing, all three transducers are configured to receive any (direct) acoustic pulse reflections. As shown in FIG. 5, the acoustic pulse emitted from one transducer may be reflected to another transducer, and one or more of the other transducers may not detect any reflections. Nevertheless, a standoff distance can be determined if at least one of the three transmitted acoustic pulses is detected by at least one of the transducers.

If more than one transducer detects an acoustic pulse reflection and/or more than one acoustic pulse reflection is detected, the information from the multiple detections may be combined to improve the standoff distance determination accuracy. In one embodiment, the time delays (or path lengths) for each detection are used to construct a system of equations that are then solved in a least-squares fashion to determine a standoff distance. In another embodiment, a beam-forming analysis is applied to the signals to improve the signal-to-noise ratio (and thereby improve the accuracy of the time delay and path length determinations) and to determine a direction of arrival. Given the path length and the arrival direction, a standoff distance may be readily calculated.

FIG. 6 illustrates the much larger limits on incidence angle provided by transducer array 202. In a situation similar to that of FIG. 4, the edge of the beam is reflected back to transducer array at an incidence angle of 22°, which is well beyond the 10° limit of the FIG. 3 embodiment. In both embodiments, the incidence angle limit will vary as a function of standoff distance, borehole diameter, and transducer (or array) size.

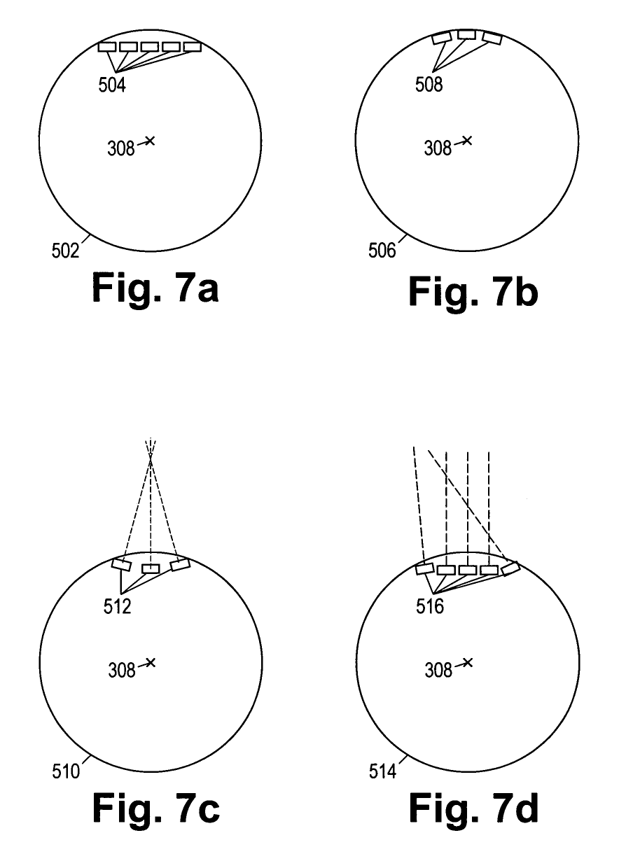

Acoustic caliper embodiment 200 is shown having an array of three parallel transducers. Contemplated embodiments include arrays of two, three, four, or more transducers. FIG. 7a shows an illustrative embodiment 502 having an array 504 of five parallel transducers. The transducers in the array need not be parallel, so long as each transducer can receive direct reflections of acoustic pulses transmitted by the other transducers. FIG. 7b shows an illustrative embodiment 506 having an array 508 of transducers oriented to the tool's circumference. FIG. 7c shows an illustrative embodiment 508 having an array 512 of transducers oriented to an external focus point. FIG. 7d shows an illustrative embodiment 514 having an array 516 of transducers oriented in an asymmetric fashion.

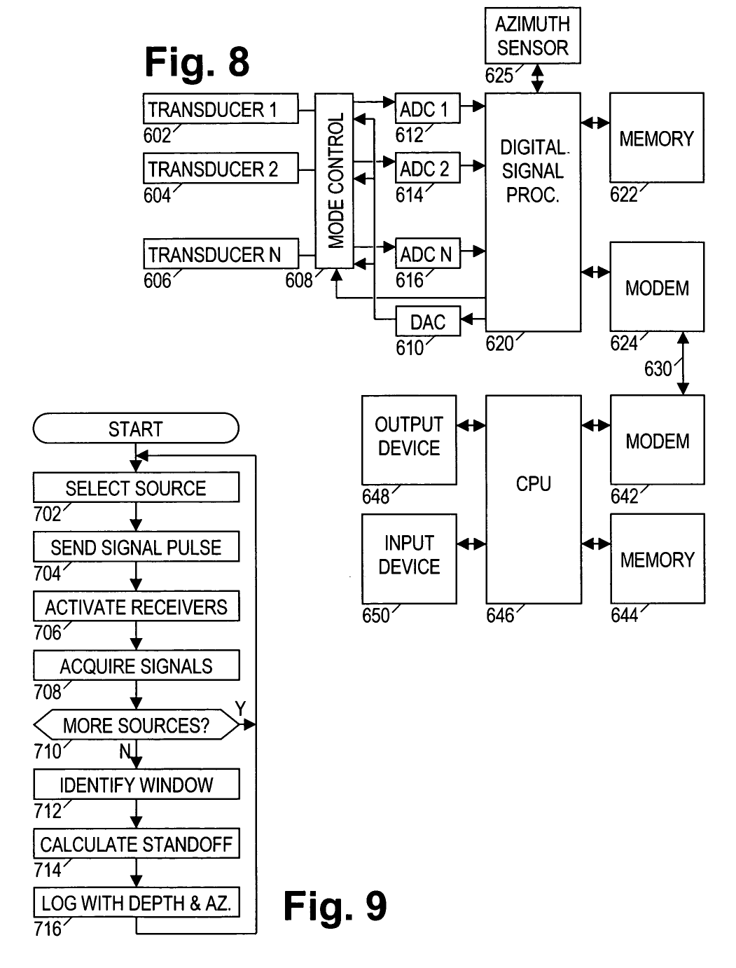

FIG. 8 is a block diagram of an illustrative logging system having an acoustic caliper tool. Acoustic transducers 602-606 are coupled to a mode control switch 608. Mode control switch 608 configures the transducers 602-606 to operate in one of multiple modes. In a receive mode, the mode control switch 608 couples each of the transducers 602-606 to a respective analog-to-digital converter (ADC) 612-616. In a transmit mode, the mode control switch 608 couples a selected one of the transducers 602-606 to a digital-to-analog converter (DAC) 610, and isolates all transducers from their respective ADCs 612-616. Mode control switch 608 operates under control of a digital signal processor (DSP) 620.

DSP 620 controls the transmission of acoustic pulses and the reception of acoustic pulse reflections. As part of the transmission process, DSP 620 may select an individual transducer to be coupled to DAC 610. DSP 620 may then provide a pulse signal to the transducer via the DAC 610. As part of the receive process, DSP 620 may operate mode control switch 608 to couple each transducer to a respective ADC. DSP 620 may then store the received signals in memory 622.

DSP 620 may process the received signals to determine a time delay associated with any acoustic pulse reflections. As part of the processing, DSP 620 may apply variable gain to compensate for attenuation, cross-correlate the receive signals with a pulse model, and distinguish primary borehole wall reflections from secondary reflections and “false” reflections caused by bubbles or debris. DSP 620 may further collect orientation measurements from an azimuth sensor 625 and associate each time delay with an azimuth value.

Each time delay may be converted into a distance measurement, and the distance measurements may be combined to determine borehole shape and size, along with a tool position within the borehole. Statistics on borehole diameter, tool offset, and tool motion may also be calculated. The conversion and combining may be performed downhole by DSP 620, or some of the processing may be performed on the surface. In any event, the time delay and azimuth measurements (and/or processed data) may be provided to a downhole modem 624 for transmission via a telemetry channel 630 to a surface modem 642. A processor (CPU) 646 collects the information, and stores the information in memory 644 and/or a nonvolatile information storage device. The processor 646 may also execute software in memory 644. The software may configure processor 646 to interact with a user via an output device 648 and an input device 650. The user may be provided with a prompt and/or one or more options on output device 648, and may respond with commands via input device 650. In response to such input, the software may configure the processor 646 to process the information collected from downhole and present the results to the user in graphical fashion. Processor 646 may calculate borehole shape and tool position based on the data provided from DSP 620, and may further provided post-processing refinement of the borehole shape and tool position calculations based on additional information, which may be stored in memory 644. The additional information (e.g., accurate borehole fluid acoustic velocity measurements, local magnetic field variations) may obtained by other logging instruments or may be provided from other sources. As an alternative to expressly calculating borehole shape and tool position, the processor 646 may simply employ the acoustic caliper measurements as a compensation parameter in the measurements of other tools.

FIG. 9 is a flow diagram of an illustrative method that may be implemented by a processor or microcontroller in the acoustic caliper tool (e.g., DSP 620). In block 702, the processor selects a transducer from which to send an acoustic pulse. In block 704, the processor causes the selected transducer to transmit the acoustic pulse. In block 706, the processor places the transducer array in receive mode. In block 708, the processor acquires and stores the receive signals. In block 710, the processor checks to see if an acoustic pulse needs to be sent from another transducer. (In one embodiment, the processor fires each transducer in turn.) If so, the processor selects the next transducer in block 702. Otherwise, in block 712 the processor operates on each of the receive signals to identify a time window containing any acoustic signal reflections, and may process the signals within the window to estimate exact acoustic pulse travel times.

In block 714, the processor may calculate a standoff based on the estimated travel times. The relationship between standoff and travel time is determined by the borehole fluid's acoustic velocity, which can determined in a number of ways. In one embodiment, an estimated acoustic velocity is determined from observed differences in arrival times at different receivers. Initial calculations based on this estimated acoustic velocity may be refined at the surface where more accurate acoustic velocity information may be available (e.g., acoustic velocity estimates based on measurements of temperature, pressure, and borehole fluid density).

In block 716, the standoff calculation may be associated with a depth and azimuth so as to collect a log of measurements that may be used to compensate measurements by other tools and/or used to construct a model of the borehole. The processor then repeats the method beginning with block 702.

In one embodiment, the method of FIG. 9 is performed in a LWD tool. Thus the tool rotates as it progresses through the borehole. The method is performed with sufficient speed that the change in tool position and orientation is negligible during each iteration, or alternatively, that the change in tool position and orientation is small enough to be compensated for. In an alternative embodiment, acoustic pulses are sent from only a subset of the transducers (e.g., the two transducers on the ends of the array). Additionally, or alternatively, multiple transducers may be fired simultaneously. If the transmitted pulses have different frequencies, or are made orthogonal by other means, the DSP 620 can cross-correlate the pulses with the receive signal at each receiver to determine a time delay associated with each pulse. Since the source of each pulse is known, the standoff distance can be found in the same manners described above. Alternatively, such simultaneous firing may be performed with non-orthogonal signals to “steer” the resulting acoustic pulse.

Numerous variations and modifications will become apparent to those skilled in the art once the above disclosure is fully appreciated. It is intended that the following claims be interpreted to embrace all such variations and modifications.

1. An acoustic caliper that comprises:
an array of two or more transducers, wherein after an acoustic pulse is transmitted by one of the transducers each transducer listens for a reflection of the acoustic pulse.

2. The acoustic caliper of claim 1, wherein the array is attached to a rotatable tool body that houses at least one azimuthal angle sensor.

3. The acoustic caliper of claim 2, wherein the azimuthal angle sensor comprises a magnetometer.

4. The acoustic caliper of claim 3, wherein the azimuthal angle sensor is selected from a set consisting of accelerometers, inclinometers, and gyroscopes.

5. The acoustic caliper of claim 2, further comprising a signal processor configured to receive measurement signals from the transducer array, and further configured to receive a measurement signal from the at least one azimuthal angle sensor.

6. The acoustic caliper of claim 5, wherein the signal processor is configured to determine a travel time for the acoustic pulse when a reflection is detected.

7. The acoustic caliper of claim 6, wherein the signal processor is configured to determine a travel direction for the acoustic pulse when a reflection is detected by two or more transducers in the array.

8. The acoustic caliper of claim 6, wherein the signal processor is configured to convert the travel time into a standoff value.

9. The acoustic caliper of claim 6, wherein the signal processor is configured to communicate travel times and associated azimuthal angles to a surface processor that determines a borehole shape and tool position based on the travel times at different azimuthal angles.

10. The acoustic caliper of claim 1, wherein the array of transducers comprises equally-spaced transducers oriented in parallel.

11. The acoustic caliper of claim 1, wherein the array of transducers comprises at least three transducers oriented in parallel.

12. The acoustic caliper of claim 1, wherein the array of transducers comprises azimuthally-spaced transducers oriented on a focal point.

13. The acoustic caliper of claim 1, wherein the array of transducer comprises azimuthally-spaced transducers aligned with a tool circumference.

14. The acoustic caliper of claim 1, wherein the transducers in the array are piezoelectric transducers.

15. A calipering method that comprises:
transmitting an acoustic pulse from a selected transducer in an array of at least two transducers;
configuring the array to listen for a reflection of the acoustic pulse; and
determining a travel time for the acoustic pulse if a reflection is detected by at least one transducer in the array.

16. The method of claim 15, further comprising:
selecting a different transducer in the array; and
repeating said transmitting, configuring, and determining operations.

17. The method of claim 15, wherein the reflection is detected by a transducer different than the selected transducer.

18. The method of claim 17, further comprising:
converting the travel time into a standoff value; and
associating the standoff value with an azimuthal direction.

19. The method of claim 18, further comprising:
determining a borehole shape and a tool position based on measurements of standoff values as a function of azimuthal direction.

20. The method of claim 15, wherein the array comprises equally-spaced transducers oriented in parallel.

21. The method of claim 15, wherein the array comprises at least three transducers oriented in parallel.

22. The method of claim 15, wherein the array of transducers comprises azimuthally-spaced transducers oriented on a focal point.

23. The method of claim 15, wherein the array comprises azimuthally-spaced transducers aligned with a tool circumference.

24. The method of claim 15, wherein the transducers in the array are piezoelectric transducers.

25. An apparatus that comprises:
an array means for transmitting acoustic pulses and receiving acoustic pulse reflections from borehole walls; and
a processing means for determining travel times associated with received acoustic pulse reflections.

26. The apparatus of claim 25, further comprising:
an orientation means for providing an azimuthal angle to be associated with travel times determined by the processing means.
